(19) United States
(12) Patent Application Publication
(10) Pub. No.: US 2013/0305088 A1
(43) Pub. Date: Nov. 14, 2013

(54) ELECTRONIC DEVICE AND TEST CARD THEREOF

(71) Applicants: HONG FU JIN PRECISION INDUSTRY (SHENZHEN) CO.,LTD., Shenzhen (CN); HON HAI PRECISION INDUSTRY CO., LTD., New Taipei (TW)

(72) Inventors: ZHI-GANG XU, Shenzhen (CN); BING LI, Shenzhen (CN); SHUN WANG, Shenzhen (CN); WEI-HSIEN TSENG, New Taipei (TW)

(73) Assignees: HON HAI PRECISION INDUSTRY CO., LTD., New Taipei (TW); HONG FU JIN PRECISION INDUSTRY (shenZhen) CO.,LTD. LTD., Shenzhen (CN)

(21) Appl. No.: 13/862,468

(22) Filed: Apr. 15, 2013

(30) Foreign Application Priority Data
May 8, 2012 (CN) 201210139791.7

(51) Int. Cl. G06F 11/273

(52) U.S. Cl. CPC G06F 11/273
USPC 714/25

(57) ABSTRACT

A testing card includes a power interface, a plurality of serial ports connected to a plurality of test instruments. The microprocessor includes a processing unit having been burnt with a plurality of test programs, the processing unit is configured to execute one of the test programs according a user selection and generate a test command, and a serial ports management unit configured to convert the test command into a control signal, and send the control signal to a corresponding test instrument via the corresponding one of the serial port to control the test instrument to test a target device. An electronic device using the test card is also provided.

### BACKGROUND

1. Technical Field

The present disclosure relates to electronic devices and test cards for electronic devices, and particularly to, an electronic device having a test card and a test card having a micro processor.

2. Description of Related Art

Functions of electronic devices are tested during manufacturing. The computer for controlling the fixtures and the test instruments runs a number of test programs. However, each of the test instruments needs a computer, and the computer only installs and runs corresponding test programs. One electronic device needs matching equipment; it is a waste of resources and cannot satisfy the requirement of mass production of the electronic devices.

Therefore, what is needed is an electronic device and a test card to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device having a test card in accordance with a first exemplary embodiment.

FIG. 2 is a block diagram of a test system using the electronic device having the test card, such as the one of FIG. 1, in accordance with the exemplary embodiment.

FIG. 3 is a block diagram of a test system using an electronic device having a test card in accordance with a second exemplary embodiment.

### DETAILED DESCRIPTION

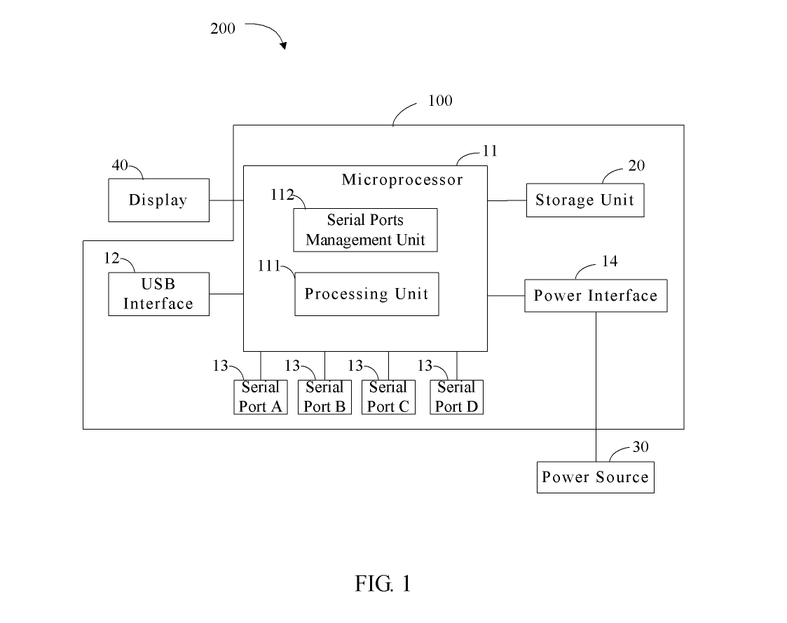

FIG. 1 is a first exemplary embodiment of a disclosure of an electronic device 200. The electronic device 200 includes a test card 100. The test card 100 includes a microprocessor 11 and a storage unit 20. In the embodiment, the microprocessor 11 is an advanced RISC machines (ARM) platform based microprocessor. The test card 100 also includes a power interface 14 and a number of data interfaces including a universal serial bus (USB) interface 12, a number of serial ports 13, and a bus interface (not shown). The microprocessor 11 includes a processing unit 111 and a serial ports management unit 112.

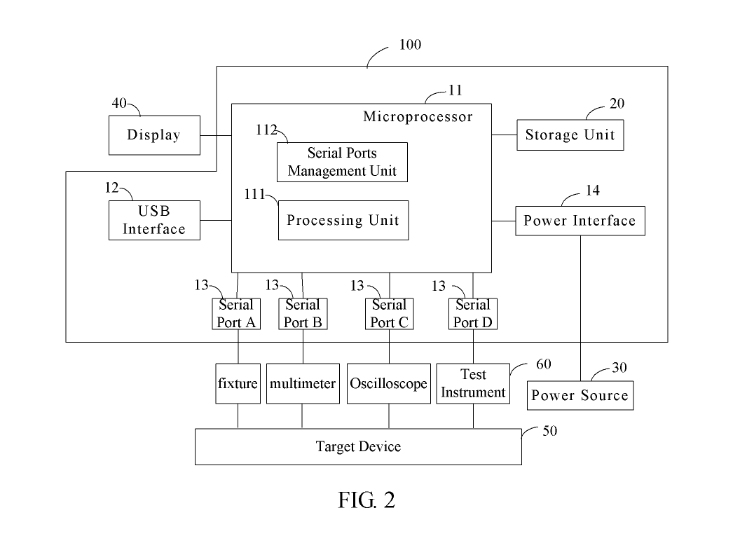

FIG. 2 is a block diagram of a test system using the electronic device 200 having the test card 100. The test card 100 is connected to a power source 30 via the power interface 14, which is connected to an input unit (not shown), such as a keyboard and a cursor device, for receiving a user's selection, via the USB interface 12, and connected to a display 40 via a display interface (not shown), such as a Video Graphics Array (VGA) interface or a Digital Visual Interface (DVI) interface. A number of test instruments 60 are respectively connected to the serial ports 13 for testing a target device 50. For example, as shown in FIG. 2, a fixture is connected to the serial port A, a multimeter is connected to the serial port B, and an oscilloscope is connected to the serial port C.

A number of test programs are burnt into the processing unit 111 of the microprocessor 11, and the processing unit 111 executes one of the test programs according to a user selection and generates a test command associated therewith. The serial ports management unit 112 converts the test command into a control signal which can be read by a corresponding test instrument 60, and sends the control signal to the corresponding test instrument 60 via the corresponding one of the serial port 13. The test instrument 60 tests the target device 50 in response to the control signal and feedbacks a test result. The serial ports management unit 112 receives the test result from the serial port 13, and the processing unit 111 further stores the test result in the storage unit 20 and drives the display 40 to display the test result. The storage unit 20 can be a flash memory.

In this embodiment, the input device is used for receiving a user selection. Different test programs may be executed by the processing unit 111 to control different test instruments 60 to test different target devices 50.

In this embodiment, the test card 100 employs a ARM platform based microprocessor 11 and has a smaller size and low cost.

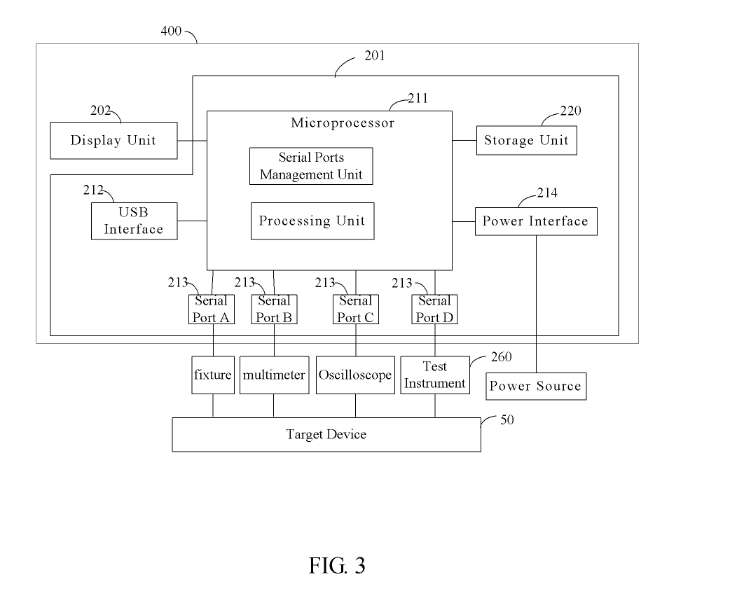

FIG. 3 shows a test system using an electronic device 400 having a test card 210 according to a second embodiment. The electronic device 200 is similar to the electronic device 100 described in the first embodiment. The electronic device 200 includes a test card body 201 and a display unit 202. The test card body 201 includes a microprocessor 211, a storage unit 220, a USB interface 212, a number of serial ports 213 and a power interface 214. The difference between the electronic device 102 and 101 is that the test card body 201 and the display unit 202 are accommodated in a housing. The electronic device 200 is connected to a number of test instruments 260 via the serial ports 13.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A test card comprising:
a power interface;
a plurality of serial ports for being connected to a plurality of test instruments;
a microprocessor comprising
a processing unit comprising a plurality of test programs burnt therein, the processing unit being configured to execute one of the test programs according to a user's selection and generate a test command associated therewith;
a serial port management unit configured to convert the test command into a control signal, and send the control signal to a corresponding test instrument via one of the serial ports to control the test instrument to test a target device.

2. The test card as described in claim 1, wherein the microprocessor is an advanced RISC machines platform based microprocessor.

3. The test card as described in claim 1, further comprising a USB interface connected to an input unit for receiving the user's selection.

4. The test card as described in claim 3, wherein the input unit is a keyboard or a cursor device.

5. The test card as described in claim 1, wherein the test card further comprise a storage unit, the processing unit is further configured for receiving a test result from the serial port feedbacked by the test instrument and storing the test result in the storage unit.

6. The test card as described in claim 5, wherein the storage unit is a flash memory.

7. An electronic device comprising:
a display;
a test card connected to the display, comprising
a power interface;
a plurality of serial ports for being respectively connected to a plurality of test instruments;
a microprocessor comprising
a processing unit comprising a plurality of test programs burnt therein, the processing unit being configured to execute one of the test programs according to a user selection and generate a test command associated therewith;
a serial port management unit configured to convert the test command into a control signal, and send the control signal to a corresponding test instrument via one of the serial ports to control the test instrument to test a target device;
wherein the processing unit is further configured to drive the display to display a test result.

8. The electronic device as described in claim 7, wherein the microprocessor is an advanced RISC machines platform based microprocessor.

9. The electronic device as described in claim 7, further comprising a USB interface connected to an input unit for receiving the user selection.

10. The electronic device as described in claim 9, wherein the input unit is a keyboard or a cursor device.

11. The electronic device as described in claim 7, wherein the test card further comprise a storage unit, the processing unit is further configured for receiving a test result from the serial port feedbacked by the test instrument and storing the test result in the storage unit.

12. The electronic device as described in claim 11, wherein the storage unit is a flash memory.
